(19) United States
(12) Patent Application Publication
(10) Pub. No.: US 2005/0195705 A1
(43) Pub. Date: Sep. 8, 2005

(54) Optical pickup device

(76) Inventors: Dong-ik Shin, Kyunggi-do (KR); Won-Jae Hwang, Seoul (KR); Chon-Su Kyong, Seoul (KR)

Correspondence Address: GOTTLIEB RACKMAN & REISMAN PC, 270 MADISON AVENUE, 8TH FLOOR, NEW YORK, NY, 100160601, US

(21) Appl. No.: 10/910,695

(22) Filed: Aug. 2, 2004

(30) Foreign Application Priority Data
Mar. 4, 2004 (KR) 2004-14642

(51) Int. Cl. G11B 7/00

(52) U.S. Cl. 369/44.23; 369/44.37

(57) ABSTRACT

The optical pickup device includes a light emitting unit for emitting a light beam focused on an optical disc having different track pitches; an optical unit for focusing the light beam emitted from the light emitting unit on the optical disc, dividing the light beam reflected from the optical disc into a plurality of diffractive light beams, and transmitting the diffractive light beams to the outside; and a light receiving unit for receiving the diffractive light beams from the optical unit to calculate a focusing error signal and a tracking error signal.

### BACKGROUND OF THE INVENTION

1. Field of the Invention

The present invention relates to an optical pickup device, and more particularly to an optical pickup device which detects a tracking error signal (TES) to compensate for a tracking offset generated by different track pitches of various optical discs, so that it can be compatible with optical discs having different track pitches.

2. Description of the Related Art

Recently, due to the conversion of data into large amounts of data, there have been developed a variety of optical discs for storing data using an optical method adapted to vary a light transmissivity, reflectivity, phase, and polarization, and reading a variation in the stored data. The optical disc is configured in the form of a circular disc, and contains fine grooves each having a predetermined size almost equal to a wavelength of a laser beam.

Optical discs are typically classified into compact discs (CDs) and digital versatile discs (DVDs). CDs are classified into CD-ROMs (CD Read Only Memories), and CD-RAMs (CD Random Access Memories), etc. DVDs are classified into DVD−Rs (DVD-Recordable), DVD−RWs (DVD-Recordable & Writable), DVD+Rs, DVD+RWs, DVD-ROMs, and DVD-RAMs, etc. The track pitch characteristics depending on category information of the aforementioned optical discs are described in the following Table 1.

TABLE 1

| Category | Track Pitch |
|---|---|
| CD | 1.6 μm |
| DVD − R/RW | 0.74 μm |
| DVD + R/RW | 0.74 μm |
| DVD − ROM | 0.74 μm |
| DVD − RAM (Version 1.0) | 0.74 μm |
| DVD − RAM (Version 2.0) | 0.615 μm |

With reference to Table 1, a tracking servo is required to allow an objective lens to travel along a track of the optical disc, so that a variety of signals generated from the aforementioned optical discs shown in Table 1 can be read by the tracking servo. Typically, a push-pull (PP) method shown in FIG. 1 has been widely adapted to generate an error signal for the tracking servo.

As shown in FIG. 1, the push-pull (PP) method adapts a difference in the quantity of light received in a photodiode divided into four sections (a, b, c, and d) as a tracking error signal (TES), and this tracking error signal (TES) can be represented by the following Equation 1:
TES=(a+b)−(c+d) [Equation ]

In accordance with the method for detecting the tracking error signal (TES) using the aforementioned PP method, there arises a balanced light distribution of a photodiode in the case where a light beam focused on the optical disc travels along the center of the track, such that the value of TES shown in Equation 1 is equal to zero, as denoted by TES=0. However, where the light beam focused on the optical disc deviates from the track center, there arises an unbalanced light distribution of the photodiode, such that the value of TES shown in Equation 1 is not equal to zero, as denoted by TES≠0.

Although the push-pull (PP) method can be theoretically applied to all kinds of optical discs, there arises an unexpected tracking error offset when an optical axis of the objective lens moves to other positions, such that it cannot adapt such optical discs as recordable discs.

Therefore, a differential push-pull (DPP) method has been newly developed as another method for detecting the tracking error signal (TES) from the optical disc. A representative differential push-pull (DPP) method has been disclosed in Korean Patent Laid-open Publication No. 2001-0098602, which is hereby incorporated by reference.

Referring to FIG. 2, the optical pickup device 1 disclosed in Korean Patent Laid-open Publication No. 2001-0098602 includes a laser light source 2 for generating a light beam B; a diffraction unit 3 for diffracting the light beam B emitted from the laser light source 2; a beam splitter 4 for transmitting the light beam B, or reflecting the light beam B in a predetermined direction; a collimator lens 5 for generating parallel light flux; an objective lens 7 for focusing the light beam B on the surface of an optical disc 6; and a photodetector 8 for receiving a light beam reflected from the optical disc 6.

Referring to FIG. 3, the photodetector 8 contained in the optical pickup device 1 includes a main photodetector 8a and two side photodetectors 8b and 8c. The main photodetector 8a is divided into four sections, and allows the four sections to receive a main spot (MS) beam. The side photodetectors 8b and 8c are each divided into two horizontal sections, so that they can receive a side spot (SS) beam.

In this case, output signals of individual sections of the photodetectors 8a, 8b and 8c are denoted by A, B, C, D, E, F, G, and H, as shown in FIG. 3. Using a prescribed calculation between the output signals A to H of the photodetectors 8a to 8c, the tracking error signal (TES) can be represented by the following Equation 2:

$$\begin{matrix}MPP = ( B + C ) - ( A + D ) \\ SPP1 = E - F \\ SPP2 = G - H \\ TES = MPP - k \times \{ SPP1 + SPP2 \} \\ = \{ ( B + C ) - ( A + D ) \} - k \times \{ ( E - F ) + ( G - H ) \}\end{matrix} \qquad [ Equation 2 ]$$

where, MPP is a main push-pull (PP) signal of the main photodetector 8a, SPP1 and SPP2 are side push-pull (PP) signals of the side photodetectors 8b and 8c, respectively, and k is a coefficient.

In more detail, the main photodetector 8a and the side photodetectors 8b and 8c generate push-pull (PP) signals, respectively, such that a direct current (DC) offset of a differential push-pull (DPP) signal is not generated at the same time that the tracking error signal (TES) occurs, resulting in a high-precision servo and increased recording density.

However, in accordance with the aforementioned differential push-pull (DPP) method, where the main beam (MB) and the side beam (SB) are focused on the track pitch center of the DVD−R/RW, DVD+R/RW, and DVD-ROM, etc., each having the track pitch of 0.74 μm, to detect the tracking error signal (TES) as shown in FIG. 4a, the side beam (SB) is not focused on the center of a track pitch 0.615 μm of the DVD-RAM (version 2.0) as shown in FIG. 4b, resulting in a lowered side beam signal.

In conclusion, it is difficult to adapt the conventional differential push-pull (DPP) method to an optical pickup device capable of allowing various optical discs having different track pitches to be compatible with each other.

### SUMMARY OF THE INVENTION

Therefore, the present invention has been made in view of the above problems, and it is an object of the invention to provide an optical pickup device compatible with an optical disc having different track pitches.

It is another object of the invention to provide an optical pickup device using a detection method applicable to a tracking error signal (TES) of an optical disc having different track pitches.

It is yet another object of the invention to provide an optical pickup device using a detection method which does not generate crosstalk of a focusing error signal (FES) and a defocusing phenomenon varying with temperature.

In accordance with the present invention, these objects are accomplished by providing an optical pickup device comprising: a light emitting unit for emitting a light beam focused on an optical disc having different track pitches; an optical unit having a hologram optical element capable of dividing the light beam reflected from the optical disc into a plurality of diffractive light beams and transmitting the divided diffractive light beams to an external part, in order to focus the light beams emitted from the light emitting unit on the optical disc; and a light receiving unit where a predetermined optical detection pattern adapted to receive the diffractive light beams received from the optical unit is formed, in order to calculate a focusing error signal (FES) and a tracking error signal (TES) according to distribution of the diffractive light beams received in the predetermined optical detection pattern.

Preferably, the optical unit includes: an objective lens for focusing the light beam emitted from the light emitting unit on the optical disc; a collimator lens for converting the light beam emitted from the light emitting unit into a parallel light beam; a beam splitter for branching the light beam emitted from the light emitting unit to the optical disc, refracting individual optical axes of the diffractive light beams which are reflected from the optical disc, split into a plurality of sections by the hologram optical element, and incident to the beam splitter, by a predetermined angle, and transmitting the refracted diffractive light beams to the light receiving unit; and a light receiving lens for focusing the diffractive light beams received from the beam splitter on the light receiving unit.

Preferably, the hologram optical element controls its optical axis center to be equal to that of the objective lens, and is integrated with the objective lens, so that it is interoperable with the objective lens.

Preferably, the hologram optical element includes a diffraction pattern divided into two sections, transmits a zero-order diffractive light beam divided into a plurality of zero-order diffractive light beams in the diffraction pattern such that the plurality of zero-order diffractive light beams are adjacent to each other to the light receiving unit, and at the same time transmits a 1st-order diffractive light beam divided into a plurality of 1st-order diffractive light beams in the diffraction pattern such that the plurality of 1st-order diffractive light beams are separated from each other to the light receiving unit.

Preferably, the light receiving unit includes: a zero-order optical detection pattern divided into two sections adapted to receive the 2-section zero-order diffractive light beams, respectively; and a 1st-order optical detection pattern where 2-section patterns are formed to receive the 2-section 1st-order diffractive light beams, respectively, in which the 2-section patterns receiving the 1st-order diffractive light beams are each divided into a plurality of sections.

Preferably, the light receiving unit calculates a focusing error signal (FES) by applying a spot size detection (SSD) method to distribution of the 1st-order diffractive light beams received in the 1st-order optical detection pattern.

Preferably, the light receiving unit calculates a zero-order tracking error signal by applying a push-pull (PP) method to distribution of the zero-order diffractive light beams received in the zero-order optical detection pattern, calculates a 1st-order tracking error signal by applying a correct far field (CFF) method to distribution of the 1st-order diffractive light beams received in the 1st-order optical detection pattern, and calculates a tracking error signal by combining the zero-order tracking error signal with the 1st-order tracking error signal.

Preferably, the light receiving unit includes: a zero-order optical detection pattern divided into two sections adapted to receive the 2-section zero-order diffractive light beams, respectively, in which the 2-section patterns receiving the zero-order diffractive light beams are each divided into a plurality of sections; and a 1st-order optical detection pattern where 2-section patterns are formed to receive the 2-section 1st-order diffractive light beams, respectively, in which the 2-section patterns receiving the 1st-order diffractive light beams are each divided into a plurality of sections.

Preferably, the light receiving unit calculates the focusing error signal (FES) by applying a spot size detection (SSD) method to distribution of the 1st-order diffractive light beams received in the 1st-order optical detection pattern.

Preferably, the light receiving unit calculates a zero-order tracking error signal by applying a push-pull (PP) method to distribution of the zero-order diffractive light beams received in the zero-order optical detection pattern, calculates a 1st-order tracking error signal by applying a correct far field (CFF) method to distribution of the 1st-order diffractive light beams, and calculates a tracking error signal by combining the zero-order tracking error signal with the 1st-order tracking error signal.

### BRIEF DESCRIPTION OF THE DRAWINGS

The above objects, and other features and advantages of the present invention will become more apparent after reading the following detailed description when taken in conjunction with the drawings, in which:

FIG. 1 is a schematic view illustrating a conventional photodiode divided into 4 sections;

FIG. 2 is a schematic view illustrating a conventional optical pickup device;

FIG. 3 is a conceptual diagram illustrating the relationship between the conventional photodetector and optical spots;

FIGS. 4a˜4b are plan views illustrating optical spots focused on optical discs having different track pitches;

FIG. 5 is a schematic view illustrating an optical pickup device in accordance with a preferred embodiment of the present invention;

FIG. 6a is a conceptual diagram illustrating the relationship between a pattern of a hologram optical element and a pattern of an optical spot formed on a light receiving part in accordance with a first preferred embodiment of the present invention;

FIG. 6b is a conceptual diagram illustrating the relationship between the light receiving part and the optical spot in accordance with a first preferred embodiment of the present invention;

FIG. 6c is a conceptual diagram illustrating a 1st optical detection pattern varying with temperature in accordance with a first preferred embodiment of the present invention;

FIG. 7a is a conceptual diagram illustrating the relationship between a pattern of a hologram optical element and a pattern of an optical spot formed on a light receiving part in accordance with a second preferred embodiment of the present invention;

FIG. 7b is a conceptual diagram illustrating the relationship between the light receiving part and the optical spot in accordance with a second preferred embodiment of the present invention;

FIG. 8a is a conceptual diagram illustrating the relationship between a pattern of a hologram optical element and a pattern of an optical spot formed on a light receiving part in accordance with a third preferred embodiment of the present invention;

FIG. 8b is a conceptual diagram illustrating the relationship between the light receiving part and the optical spot in accordance with a third preferred embodiment of the present invention;

FIG. 9a is a conceptual diagram illustrating the relationship between a pattern of a hologram optical element and a pattern of an optical spot formed on a light receiving part in accordance with a fourth preferred embodiment of the present invention;

FIG. 9b is a conceptual diagram illustrating the relationship between the light receiving part and the optical spot in accordance with a fourth preferred embodiment of the present invention;

FIG. 10a is a conceptual diagram illustrating the relationship between a pattern of a hologram optical element and a pattern of an optical spot formed on a light receiving part in accordance with a fifth preferred embodiment of the present invention; and

FIG. 10b is a conceptual diagram illustrating the relationship between the light receiving part and the optical spot in accordance with a fifth preferred embodiment of the present invention.

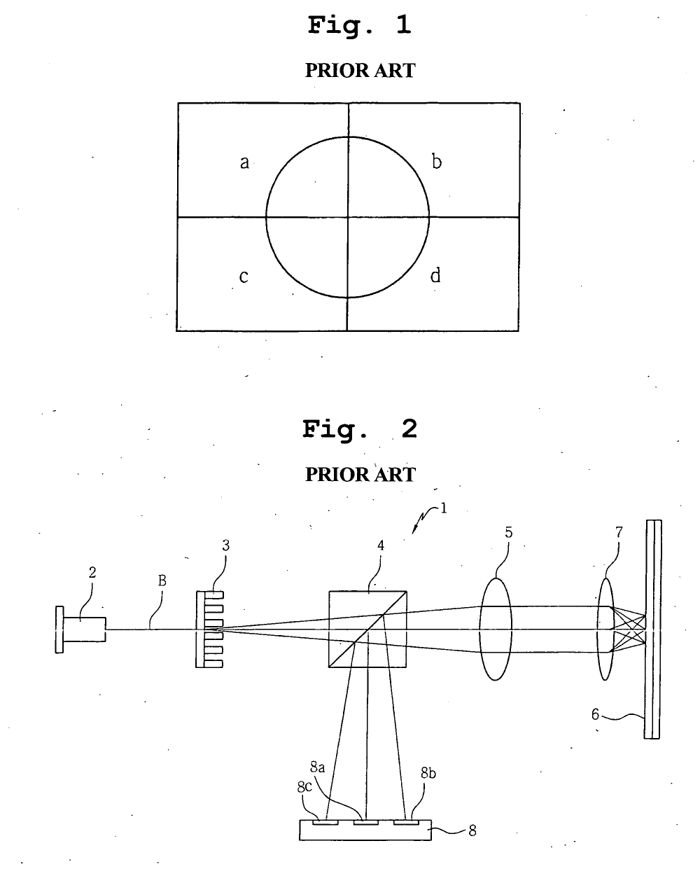

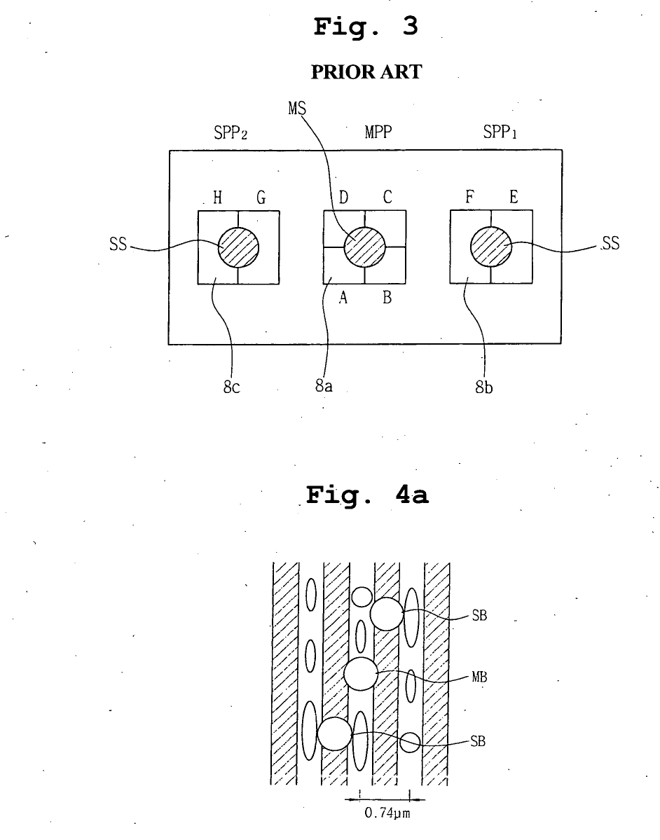

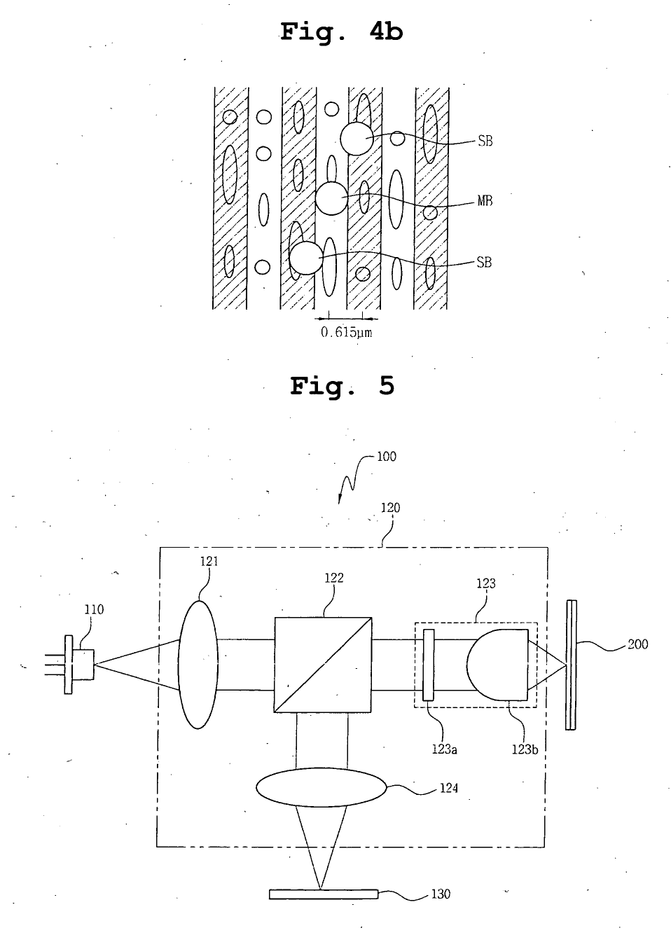

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

FIG. 5 is a schematic view illustrating an optical pickup device in accordance with a preferred embodiment of the present invention.

Referring to FIG. 5, an optical pickup device 100 according to the present invention includes a light transmitting part 110, an optical unit 120, and a light receiving part 130.

The light transmitting part 110 is formed of a short-wavelength laser diode, records audio and video data on an optical disc 200 where predetermined track pitches are formed, and emits a light beam to read the data recorded on the optical disc 200.

The optical unit 120 includes a collimator lens 121, a beam splitter 122, an actuator 123, and a light receiving lens 124. The light beam emitted from the light transmitting part 110 is focused on the track pitches formed on the optical disc 200, and transmits the light beam reflected from the optical disc 200 to the light receiving part 130.

The collimator lens 121 converts the light beam emitted from the light transmitting part 110 into a parallel light beam. The optical element 120 may also be configured in the form of a more simplified structure without the collimator lens 121, however, it unavoidably produces high spherical aberration and excessively reduces intensity of the light beam focused on the optical disc 200.

The beam splitter 122 branches the light beam received from the light transmitting part 110 to the optical disc 200, and refracts an optical axis of the light beam reflected from the optical disc 200 by a predetermined angle of 90°, such that it can transmit the reflected light beam to the light receiving part 130.

The actuator 123 includes a hologram optical element 123a and an objective lens 123b. The actuator 123 must control the optical axis center of the hologram optical element 123a to be equal to that of the objective lens 123b, such that it can precisely focus the light beam on the optical disc 200 and can also perform a precise tracking operation on the same optical disk 200 on the basis of a focusing error signal (FES) and a tracking error signal (TES). Therefore, the hologram optical element 123a must be integrated with the objective lens 123b in the actuator 123, and the actuator 123 is then operated.

The hologram optical element 123a is divided into predetermined patterns to produce the focusing and tracking error signals FES and TES. In more detail, the hologram optical element 123a splits the light beam reflected from the optical disc 200 into either two diffractive light beams composed of zero and 1st-order diffractive light beams or three diffractive light beams composed of zero, +1st, and −1st-order diffractive light beams, and transmits the split light beams to the light receiving part 130.

The objective lens 123b receives a parallel light beam from the collimator lens 121, and focuses the received parallel light beam on the optical disc 200 having different track pitches.

The light receiving lens 124 receives the light beam, which has been reflected from the optical disc 200 and has then been refracted by the beam splitter, and focuses the received light beam on the light receiving part 130.

The light receiving part 130 is formed of a photodiode having prescribed optical detection patterns, and carries out a prescribed calculation associated with the optical intensity distribution of a light spot received in the optical detection patterns, such that it can detect the focusing and tracking error signals FES and TES of the optical disc 200 having different track pitches.

In more detail, the light receiving part 130 receives either the zero and 1st-order diffractive light beams or the zero, +1st, and −1st-order diffractive light beams from the hologram optical element 123a of the optical unit 120, and detects/calculates the focusing and tracking error signals FES and TES on the basis of the distribution of the diffractive light beams focused on a predetermined optical detection pattern. The light receiving part 130 includes a module for detecting error signals of a device such as a microprocessor capable of calculating the focusing and tracking error signals FES and TES.

The method for detecting the focusing and tracking error signals FES and TES of the optical pickup device 100 shown in FIG. 5 according to the present invention will hereinafter be described.

The collimator lens 121 converts the light beam emitted from the light transmitting part 110 into the parallel light beam. The parallel light beam is split from the beam splitter 122. The objective lens 123b focuses the split light beam onto the track pitch of the optical disc 200, and the split light beam is then reflected from the optical disc 200. The reflected light beam passes through the objective lens 123b, and is then split into the zero and 1st-order diffractive light beams, or the zero, +1st, and −1st-order diffractive light beam by the hologram optical element 123a. The beam splitter 122 refracts individual optical axes of the split diffractive light beams by 90°. The light receiving lens 124 focuses the refracted light beams on the light receiving part 130. The light receiving part 130 detects the focusing and tracking error signals FES and TES, and calculates them. Thereafter, upon receipt of the focusing and tracking error signals FES and TES, a focusing servo and a tracking servo are driven to precisely form an optical spot on the track pitch of the optical disc 200.

A method for detecting the focusing and tracking error signals FES and TES using individual patterns of the hologram optical element 123a and the light receiving part 130 according to the present invention will hereinafter be described.

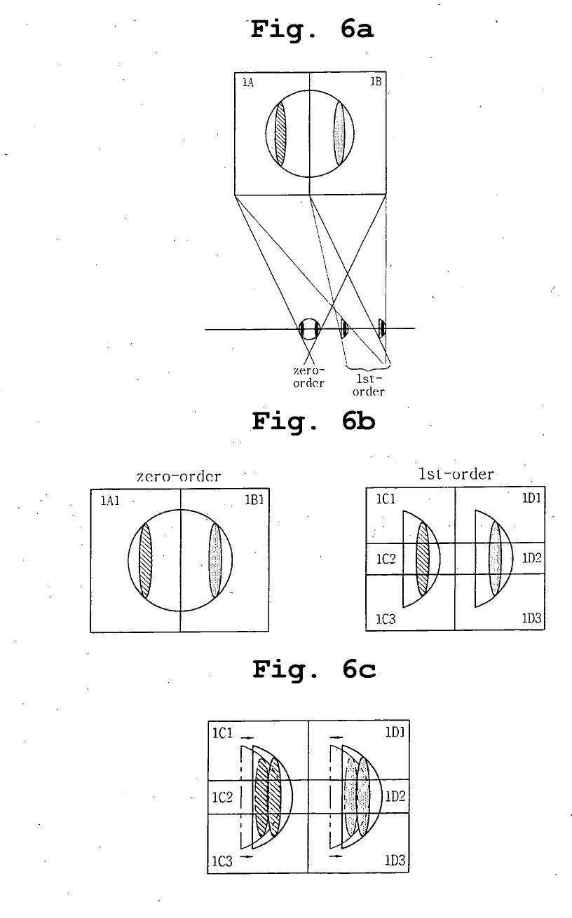

FIG. 6a is a conceptual diagram illustrating the relationship between a pattern of the hologram optical element 123a and a pattern of an optical spot formed on a light receiving part 130 in accordance with a first preferred embodiment of the present invention. FIG. 6b is a conceptual diagram illustrating the relationship between the light receiving part 130 and the optical spot in accordance with a first preferred embodiment of the present invention. FIG. 6c is a conceptual diagram illustrating a 1st optical detection pattern varying with temperature in accordance with a first preferred embodiment of the present invention.

Referring to FIG. 6a, the hologram optical element 123a according to the first preferred embodiment of the present invention is divided into two sections 1A and 1B. The light beam reflected from the optical disc 200 passes through the hologram optical element 123a, and is divided into zero and 1st-order diffractive light beams by the hologram optical element 123a, such that the zero and 1st-order diffractive light beams are focused on the light receiving part 130. In this case, individual ends of the zero and 1st-order diffractive light beams are focused on the rear of the light receiving part 130, such that an upright image is formed on the light receiving part 130. The other end of the 1st-order diffractive light beam is focused on the front of the light receiving part 130, such that an inverted image is formed on the light receiving part 130. The zero and 1st-order diffractive light beams focused on the light receiving part 130 form optical detection patterns according to prescribed patterns shown in FIG. 6b.

In this case, a prescribed area for receiving the zero-order diffractive light beam is divided into two horizontal sections 1A1 and 1B1 in association with the 2-section patterns 1A and 1B of the hologram optical element 123a. In the meantime, a prescribed area for receiving the 1st-order diffractive light beam is divided into two horizontal sections in association with the 2-section patterns 1A and 1B of the hologram optical element 123a, and each of the two horizontal sections is divided into three vertical sections, resulting in 6 sections 1C1, 1C2, 1C3, 1D1, 1D2, and 1D3.

Upon receipt of the calculation result of output signals of the aforementioned optical detection patterns, the focusing error signal FES can be represented by the following Equation 3:
FES=(1C1+1D2+1C3)−(1D1+1C2+1D3) [Equation ]

Equation 3 indicates a typical spot size detection (SSD) method. However, one end of the 1st-order diffractive light beam (e.g., the 1A section 1A of the hologram optical element) is focused on the rear of the light receiving part 130, and the other end of the 1st-order diffractive light beam (e.g., the 1B section of the hologram optical element) is focused on the front of the light receiving part 130. Provided that the light beam is not focused on the track center of the optical disc 200, light beam intensities associated with baseball patterns focused on specific areas IC2 and ID2 contained in the optical detection pattern are different. Due to the above difference between light beam intensities, there may arise focus crosstalk when the focusing error signal (FES) is detected by the typical spot size detection (SSD) method shown in Equation 3.

In order to prevent the focus crosstalk from being generated, it is preferable to detect the focusing error signal (FES) using the following Equation 4:
FES=(1C1+1D2+1C3)−(1D1+1C2+1D3)−kf1×(1C2−1D2) [Equation 4]
where, kf1 is a correction constant for an optimized focusing error signal (FES).

With reference to Equation 4, the influence of the focus crosstalk can be greatly reduced by removing a correction term denoted by kf1×(1C2−1D2) from the typical spot size detection (SSD) method shown in Equation 3.

Referring back to FIG. 6b, upon receipt of the calculation result between the zero-order optical detection pattern divided into 2 sections 1A1 and 1B1 and the 1st-order optical detection pattern divided into 6 sections 1C1, 1C2, 1C3, 1D1, 1D2, and 1D3, the tracking error signal (TES) can be acquired from the following Equation 5:

$$\begin{matrix}TES0 = 1 A1 - 1 B1 \\ TES1 = ( 1 C1 + 1 D2 + 1 C3 ) - ( 1 D1 + 1 C2 + 1 D3 ) \\ TES = TES1 - kt1 \times TES1 \\ = ( 1 A1 - 1 B1 ) - kt1 \times \{ ( 1 C1 + 1 C2 + 1 C3 ) - \\ ( 1 D1 + 1 D2 + 1 D3 ) \}\end{matrix} \qquad [ Equation 5 ]$$

where TES0 is a term associated with the zero-order optical detection pattern of the tracking error signal (TES), and uses a push-pull (PP) method; TES1 is a term associated with the 1st-order optical detection pattern of the tracking error signal (TES), and uses a correct far field (CFF) method; and kt1 is a correction constant of the optimized tracking error signal (TES).

The push-pull (PP) method for the TES0 generates an offset depending on the movement of the objective lens 123b, and the correct far field (CFF) method for the TES1 also generates a lower offset depending on the movement of the objective lens 123b as compared to the push-pull (PP) method.

The push-pull (PP) method for the TES0 and the correct far field (CFF) method for the TES1 linearly increase specific values depending on the movement distance of the objective lens 123b within an allowable movement range (e.g., the range of about 300 μm along a track direction) of the objective lens 123b. Therefore, provided that the push-pull (PP) method for the TES0 is combined with the correct far field (CFF) method for the TES1 using a correction constant of the optimized tracking error signal (TES) such as kt1, the offset varying with the movement of the objective lens 123b can be cancelled.

In conclusion, the method for detecting the focusing and tracking error signals FES and TES according to the present invention uses an improved method in which the push-pull (PP) method adapting only one light beam and the correct far field (CFF) are combined with each other, differently from the conventional differential push-pull (DPP) method, such that it is applicable to all kinds of optical discs 200 having different track pitches.

In the meantime, a diffractive light beam received in the light receiving part 130 parallel moves to another position, such that it may be out of focus on the light receiving part 130.

However, the present invention detects the focusing error signal (FES) using the 1st-order diffractive light beam instead of the zero-order diffractive light beam. Referring to FIG. 6c, although the diffractive light beam received in the light receiving part 130 parallel moves from an original position (e.g., the dotted line part in FIG. 6c) to another position (e.g., the solid line part in FIG. 6c) due to a variation in temperature, there is no change in the output level of the tracking error signal (TES).

Therefore, the optical pickup device 100 of the present invention does not encounter the defocusing problem of the diffractive light beam received in the light receiving part 130 according to a variation in temperature.

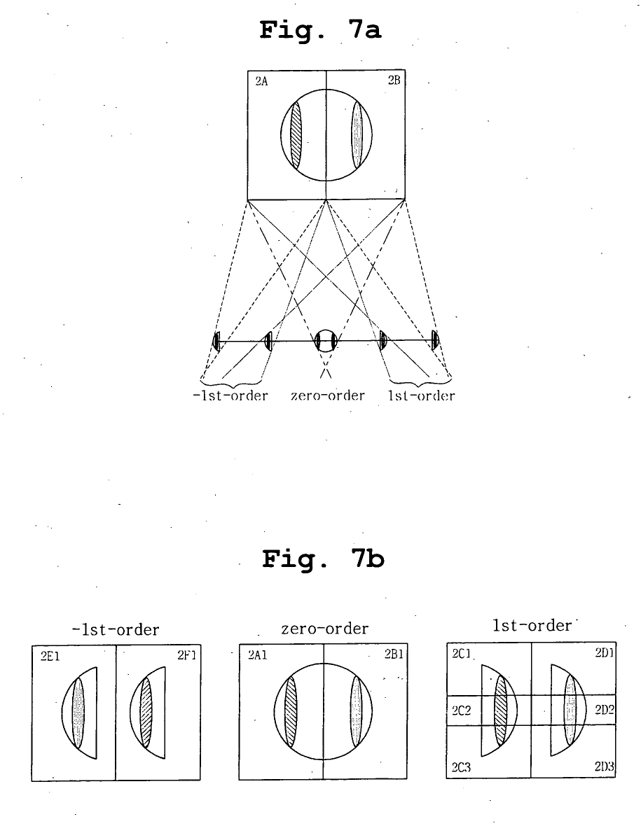

FIG. 7a is a conceptual diagram illustrating the relationship between a pattern of the hologram optical element 123a and a pattern of an optical spot formed on the light receiving part 130 in accordance with a second preferred embodiment of the present invention. FIG. 7b is a conceptual diagram illustrating the relationship between the light receiving part 130 and the optical spot in accordance with a second preferred embodiment of the present invention.

Referring to FIG. 7a, the hologram optical element 123a according to the second preferred embodiment of the present invention is divided into two sections 2A and 2B. The light beam reflected from the optical disc 200 passes through the hologram optical element 123a, and is divided into zero and ±1st-order diffractive light beams by the hologram optical element 123a, such that the zero and ±1st-order diffractive light beams (i.e., zero, +1st, and −1st-order diffractive light beams) are focused on the light receiving part 130. In this case, individual ends of the zero and ±1st-order diffractive light beams are focused on the rear of the light receiving part 130, such that an upright image is formed on the light receiving part 130. The other ends of the ±1st-order diffractive light beams are focused on the front of the light receiving part 130, such that an inverted image is formed on the light receiving part 130. The zero and ±1st-order diffractive light beams focused on the light receiving part 130 form optical detection patterns according to prescribed patterns shown in FIG. 7b.

In this case, a prescribed area for receiving the zero-order diffractive light beam is divided into two horizontal sections 2A1 and 2B1 in association with the 2-section patterns 2A and 2B of the hologram optical element 123a. In the meantime, a prescribed area for receiving the +1st-order diffractive light beam is divided into two horizontal sections in association with the 2-section patterns 2A and 2B of the hologram optical element 123a, and each of the two horizontal sections is divided into three vertical sections, resulting in 6 sections 2C1, 2C2, 2C3, 2D1, 2D2, and 2D3. A prescribed area for receiving the −1st-order diffractive light beam is divided into two horizontal sections 2E1 and 2F1 in association with the 2-section patterns 2A and 2B of the hologram optical element 123a.

Upon receipt of the calculation result of output signals of the aforementioned optical detection patterns, the focusing error signal (FES) and the tracking error signal (TES) can be detected using the following Equations 6 and 7, respectively:
FES=(2C1+2D2+2C3)−(2D1+2C2+2D3) or FES=(2C1+2D2+2C3)−(2D1+2C2+2D3)−kf2×(2C2−2D2) [Equation 6]

$$\begin{matrix}TES0 = 2 A1 - 2 B1 \\ TES1 = 2 E1 - 2 F1 \\ TES = TES0 - kt2 \times TES1 \\ = ( 2 A1 - 2 B1 ) - kt \times ( 2 E1 - 2 F1 )\end{matrix} \qquad [ Equation 7 ]$$

where TES0 is a term associated with the zero-order optical detection pattern of the tracking error signal (TES), and uses a push-pull (PP) method; TES1 is a term associated with the −1st-order optical detection pattern of the tracking error signal (TES), and uses a correct far field (CFF) method; and kf2 and kt2 are correction constants of the optimized focusing and tracking error signals FES and TES, respectively.

Referring to the comparison result between the second preferred embodiment of the present invention as shown in FIGS. 7a˜7b with the first preferred embodiment of the present invention as shown in FIGS. 6a˜6b, the hologram optical element 123a emits −1st-order diffractive light beam and thereby 2-section optical detection patterns are formed in the light receiving part 130 according to the second preferred embodiment, differently from the first preferred embodiment. Furthermore, the second preferred embodiment adapts the zero and −1st-order optical detection patterns to detect the tracking error signal (TES), whereas the first preferred embodiment adapts the zero and +1st-order optical detection patterns to detect the same tracking error signal (TES).

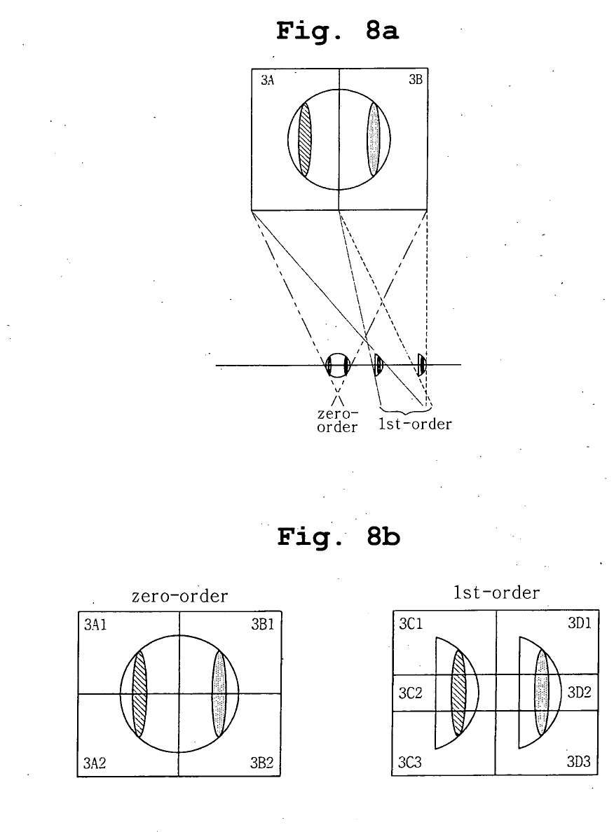

FIG. 8a is a conceptual diagram illustrating the relationship between a pattern of the hologram optical element 123a and a pattern of an optical spot formed on the light receiving part 130 in accordance with a third preferred embodiment of the present invention. FIG. 8b is a conceptual diagram illustrating the relationship between the light receiving part 130 and the optical spot in accordance with a third preferred embodiment of the present invention.

Referring to FIG. 7a, the hologram optical element 123a according to the third preferred embodiment of the present invention is divided into two sections 3A and 3B. The light beam reflected from the optical disc 200 passes through the hologram optical element 123a, and is divided into zero and 1st-order diffractive light beams by the hologram optical element 123a, such that the zero and 1st-order diffractive light beams are focused on the light receiving part 130. In this case, individual ends of the zero and 1st-order diffractive light beams are focused on the rear of the light receiving part 130, such that an upright image is formed on the light receiving part 130. The other ends of the 1st-order diffractive light beams are focused on the front of the light receiving part 130, such that an inverted image is formed on the light receiving part 130. The zero and 1st-order diffractive light beams focused on the light receiving part 130 form optical detection patterns according to prescribed patterns shown in FIG. 8b.

In this case, a prescribed area for receiving the zero-order diffractive light beam is divided into two horizontal sections in association with the 2-section patterns 3A and 3B of the hologram optical element 123a, and each of the two horizontal sections is divided into two vertical sections, resulting in 4 sections 3A1, 3A2, 3B1 and 3B2. In the meantime, a prescribed area for receiving the 1st-order diffractive light beam is divided into two horizontal sections in association with the 2-section patterns 3A and 3B of the hologram optical element 123a, and each of the two horizontal sections is divided into three vertical sections, resulting in 6 sections 3C1, 3C2, 3C3, 3D1, 3D2, and 3D3.

Upon receipt of the calculation result of output signals of the aforementioned optical detection patterns, the focusing error signal (FES) and the tracking error signal (TES) can be detected using the following Equations 8 and 9, respectively:
FES=(3C1+232+3C3)−(3D1+3C2+3D3) or FES=(3C1+3D2+3C3)−(3D1+3C2+3D3)−kf3×(3C2−3D2) [Equation 8]

$$\begin{matrix}TES0 = ( 3 A1 + 3 A2 ) - ( 3 B1 + 3 B2 ) \\ TES1 = ( 3 C1 + 3 C2 + 3 C3 ) - ( 3 D1 + 3 D2 + 3 D3 ) \\ TES = TES0 - kt3 \times TES1 \\ = \{ ( 3 A1 - 3 A2 ) - ( 3 B1 + 3 B2 ) \} - kt3 \times \\ \{ ( 3 C1 + 3 C2 + 3 C3 ) - ( 3 D1 + 3 D2 + 3 D3 ) \}\end{matrix} \qquad [ Equation 9 ]$$

where TES0 is a term associated with the zero-order optical detection pattern of the tracking error signal (TES), and uses a push-pull (PP) method; TES1 is a term associated with the 1st-order optical detection pattern of the tracking error signal (TES), and uses a correct far field (CFF) method; and kf3 and kt3 are correction constants of the optimized focusing and tracking error signals FES and TES, respectively.

Referring to the comparison result between the third preferred embodiment of the present invention as shown in FIGS. 8a˜8b with the first preferred embodiment of the present invention as shown in FIGS. 6a˜6b, the zero-order optical detection pattern of the light receiving part 130 for use in the third preferred embodiment is divided into 4 sections 3A1, 3A2, 3B1, and 3B2 whereas the zero-order optical detection pattern of the light receiving part 130 for use in the first preferred embodiment is divided into 2 sections 1A1 and 1B1.

Furthermore, if the optical disc 200 is a DVD-ROM, the method for detecting the tracking error signal (TES) according to the third preferred embodiment of the present invention may detect another tracking error signal (TES′) using the following Equation 10 indicative of a differential phase detection (DPD) method:
TES′=phase(3A1+3B2)−phase(3B1+3A2) [Equation 10]

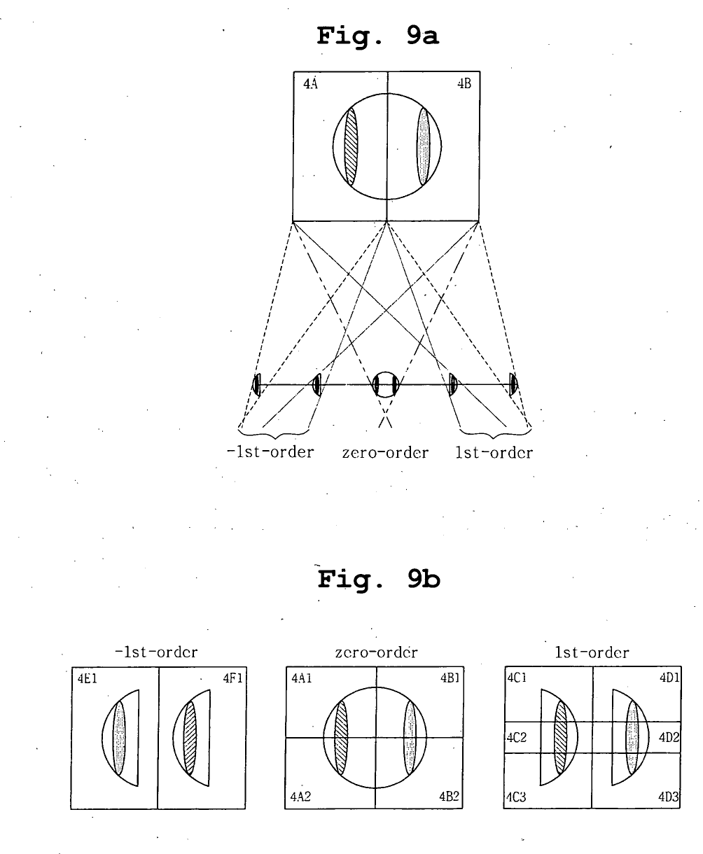

FIG. 9a is a conceptual diagram illustrating the relationship between a pattern of the hologram optical element 123a and a pattern of an optical spot formed on the light receiving part 130 in accordance with a fourth preferred embodiment of the present invention. FIG. 9b is a conceptual diagram illustrating the relationship between the light receiving part 130 and the optical spot in accordance with a fourth preferred embodiment of the present invention.

Referring to FIG. 9a, the hologram optical element 123a according to the fourth preferred embodiment of the present invention is divided into two sections 4A and 4B. The light beam reflected from the optical disc 200 passes through the hologram optical element 123a, and is divided into zero and ±1st-order diffractive light beams by the hologram optical element 123a, such that the zero and ±1st-order diffractive light beams are focused on the light receiving part 130. In this case, individual ends of the zero and ±1st-order diffractive light beams are focused on the rear of the light receiving part 130, such that an upright image is formed on the light receiving part 130. The other ends of the ±1st-order diffractive light beams are focused on the front of the light receiving part 130, such that an inverted image is formed on the light receiving part 130. The zero and ±1st-order diffractive light beams focused on the light receiving part 130 form optical detection patterns according to prescribed patterns shown in FIG. 9b.

In this case, a prescribed area for receiving the zero-order diffractive light beam is divided into two horizontal sections in association with the 2-section patterns 4A and 4B of the hologram optical element 123a, and each of the two horizontal sections is divided into two vertical sections, resulting in 4 sections 4A1, 4A2, 4B1, and 4B2. In the meantime, a prescribed area for receiving the +1st-order diffractive light beam is divided into two horizontal sections in association with the 2-section patterns 4A and 4B of the hologram optical element 123a, and each of the two horizontal sections is divided into three vertical sections, resulting in 6 sections 4C1, 4C2, 4C3, 4D1, 4D2, and 4D3. A prescribed area for receiving the −1st-order diffractive light beam is divided into two horizontal sections 4E1 and 4F1 in association with the 2-section patterns 4A and 4B of the hologram optical element 123a.

Upon receipt of the calculation result of output signals of the aforementioned optical detection patterns, the focusing error signal (FES) and the tracking error signal (TES) can be detected using the following Equations 11 and 12, respectively:
FES=(4C1+4D2+4C3)−(4D1+4C2+4D3) or FES=(4C1+4D2+4C3)−(4D1+4C2+4D3)−kf4×(4C2−4D2) [Equation 11]

$$\begin{matrix}TES0 = ( 4 A1 + 4 A2 ) - ( 4 B1 + 4 B2 ) \\ TES1 = 4 E1 - 4 F1 \\ TES = TES0 - kt4 \times TES1 \\ = ( 4 A1 - 4 A2 ) - ( 4 B1 + 4 B2 ) \} - \\ kt4 \times ( 4 E1 - 4 F1 )\end{matrix} \qquad [ Equation 12 ]$$

where TES0 is a term associated with the zero-order optical detection pattern of the tracking error signal (TES), and uses a push-pull (PP) method; TES1 is a term associated with the −1st-order optical detection pattern of the tracking error signal (TES), and uses a correct far field (CFF) method; and kf4 and kt4 are correction constants of the optimized focusing and tracking error signals FES and TES, respectively.

Referring to the comparison result between the fourth preferred embodiment of the present invention as shown in FIGS. 9a˜9b with the second preferred embodiment of the present invention as shown in FIGS. 7a˜7b, the zero-order optical detection pattern of the light receiving part 130 for use in the fourth preferred embodiment is divided into 4 sections 4A1, 4A2, 4B1, and 4B2 whereas the zero-order optical detection pattern of the light receiving part 130 for use in the second preferred embodiment is divided into 2 sections 2A1 and 2B1.

Similar to the aforementioned method shown in FIGS. 8a˜8b, if the optical disc 200 is a DVD-ROM, the method for detecting the tracking error signal (TES) according to the fourth preferred embodiment shown in FIGS. 9a˜9b may detect another tracking error signal (TES′) using the following Equation 13 indicative of a differential phase detection (DPD) method:
TES′=phase(4A1+4B2)−phase(4B1+4A2) [Equation 13]

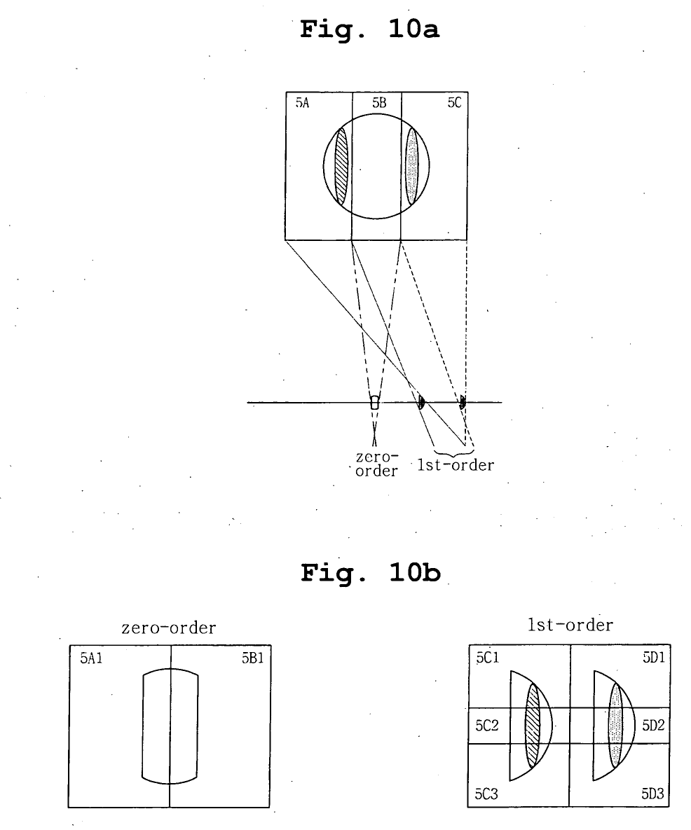

FIG. 10a is a conceptual diagram illustrating the relationship between a pattern of the hologram optical element 123a and a pattern of an optical spot formed on the light receiving part 130 in accordance with a fifth preferred embodiment of the present invention. FIG. 10b is a conceptual diagram illustrating the relationship between the light receiving part 130 and the optical spot in accordance with a fifth preferred embodiment of the present invention.

Referring to FIG. 10a, the hologram optical element 123a according to the fifth preferred embodiment of the present invention is divided into three horizontal sections 5A, 5B, and 5C. The light beam reflected from the optical disc 200 passes through the hologram optical element 123a, and is divided into zero and 1st-order diffractive light beams by the hologram optical element 123a, such that the zero and 1st-order diffractive light beams are focused on the light receiving part 130. In this case, the zero-order diffractive light beam emitted from the center area 5B of the hologram optical element 123a and the 1st-order diffractive light beam emitted from one end 5C of the hologram optical element 123a are focused on the rear of the light receiving part 130, such that an upright image is formed on the light receiving part 130. The 1st-order diffractive light beam emitted from the other end 5A of the hologram optical element 123a is focused on the front of the light receiving part 130, such that an inverted image is formed on the light receiving part 130. The zero and 1st-order diffractive light beams focused on the light receiving part 130 form optical detection patterns according to prescribed patterns shown in FIG. 10b.

In this case, a prescribed area for receiving the zero-order diffractive light beam corresponds to the center area 5B of the hologram optical element 123a, and is divided into two horizontal sections 5A1 and 5B1. In the meantime, a prescribed area for receiving the 1st-order diffractive light beam is divided into two horizontal sections in association with both ends 5A and 5C of the hologram optical element 123a, and each of the two horizontal sections is divided into three vertical sections, resulting in 6 sections 5C1, 5C2, 5C3, 5D1, 5D2, and 5D3.

Upon receipt of the calculation result of output signals of the aforementioned optical detection patterns, the focusing error signal (FES) and the tracking error signal (TES) can be detected using the following Equations 14 and 15, respectively:
FES=(5C1+5D2+5C3)−(5D1+5C2+5D3) or FES=(5C1+5D2+5C3)−(5D1+5C2+5D3)−kf5×(5C2−5D2) [Equation 14]

$$\begin{matrix}TES0 = 5 A1 - 5 B1 \\ TES1 = ( 5 C1 + 5 C2 + 5 C3 ) - ( 5 D1 + 5 C2 + 5 D3 ) \\ TES = TES0 - kt5 \times TES1 \\ = ( 5 A1 - 5 B1 ) - kt5 \times \{ ( 5 C1 + 5 C2 + 5 C3 ) - \\ ( 5 D1 + 5 C2 + 5 D3 ) \}\end{matrix} \qquad [ Equation 15 ]$$

where TES0 is a term associated with the zero-order optical detection pattern of the tracking error signal (TES), and uses a push-pull (PP) method; TES1 is a term associated with the 1st-order optical detection pattern of the tracking error signal (TES), and uses a correct far field (CFF) method; and kf5 and kt5 are correction constants of the optimized focusing and tracking error signals FES and TES, respectively.

Differently from the aforementioned first to fourth preferred embodiments of the present invention, the hologram optical element 123a for use in the fifth preferred embodiment is divided into 3 sections 5A, 5B, and 5C. Particularly, the center area 5B of the hologram optical element 123a is adapted as the zero-order optical detection pattern, and both ends 5A and 5C are adapted as the 1st-order optical detection patterns.

As apparent from the above description, the optical pickup device according to the present invention uses only one light beam differently from the conventional differential push-pull (DPP) method, such that it can be compatible with an optical disc having different track pitches.

Therefore, the optical pickup device cancels an offset using the combination result between the push-pull (PP) method and the correct far field (CFF) method which linearly increase specific values depending on the movement distance of the objective lens, such that it can precisely detect the tracking error signal (TES) of the optical disc having different track pitches.

In addition, the optical pickup device adds a correction term to the focusing error signal (FES), resulting in reduction of focus crosstalk influence.

Furthermore, the optical pickup device detects the focusing error signal (FES) using the 1st diffractive light beam which is not affected by temperature variation, such that it can prevent the defocusing phenomenon caused by temperature variation from being generated.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

1. An optical pickup device comprising:
a light emitting unit for emitting a light beam focused on an optical disc having different track pitches;
an optical unit having a hologram optical element capable of dividing the light beam reflected from the optical disc into a plurality of diffractive light beams and transmitting the divided diffractive light beams to an external part, in order to focus the light beams emitted from the light emitting unit on the optical disc; and
a light receiving unit where a predetermined optical detection pattern adapted to receive the diffractive light beams received from the optical unit is formed, in order to calculate a focusing error signal (FES) and a tracking error signal (TES) according to distribution of the diffractive light beams received in the predetermined optical detection pattern.

2. The optical pickup device according to claim 1, wherein the optical unit includes:
an objective lens for focusing the light beam emitted from the light emitting unit on the optical disc;
a collimator lens for converting the light beam emitted from the light emitting unit into a parallel light beam;
a beam splitter for splitting the light beam emitted from the light emitting unit to the optical disc, refracting individual optical axes of the diffractive light beams which are reflected from the optical disc, split into a plurality of sections by the hologram optical element, and incident to the beam splitter, by a predetermined angle, and transmitting the refracted diffractive light beams to the light receiving unit; and
a light receiving lens for focusing the diffractive light beams received from the beam splitter on the light receiving unit.

3. The optical pickup device according to claim 2, wherein the hologram optical element controls its optical axis center to be equal to that of the objective lens, and is integrated with the objective lens, so that it is interoperable with the objective lens.

4. The optical pickup device according to claim 1, wherein the light receiving unit includes:
a photodiode where a predetermined optical detection pattern adapted to receive the diffractive light beams is formed; and
an error signal detector for calculating the focusing error signal (FES) and the tracking error signal (TES) according to distribution of the diffractive light beams received in the predetermined optical detection pattern.

5. The optical pickup device according to claim 1, wherein the hologram optical element includes a diffraction pattern divided into two sections, transmits a zero-order diffractive light beam divided into a plurality of zero-order diffractive light beams in the diffraction pattern such that the plurality of zero-order diffractive light beams are adjacent to each other to the light receiving unit, and at the same time transmits a 1st-order diffractive light beam divided into a plurality of 1st-order diffractive light beams in the diffraction pattern such that the plurality of 1st-order diffractive light beams are separated from each other to the light receiving unit.

6. The optical pickup device according to claim 5, wherein either one of the zero-order diffractive light beam and the 1st-order diffractive light beam forms an upright image on the light receiving unit, and the other one of the 1st-order diffractive light beams forms an inverted image on the light receiving unit.

7. The optical pickup device according to claim 5, wherein the light receiving unit includes:
a zero-order optical detection pattern divided into two sections adapted to receive the 2-section zero-order diffractive light beams, respectively; and
a 1st-order optical detection pattern where 2-section patterns are formed to receive the 2-section 1st-order diffractive light beams, respectively, in which the 2-section patterns receiving the 1st-order diffractive light beams are each divided into a plurality of sections.

8. The optical pickup device according to claim 7, wherein the light receiving unit calculates a focusing error signal (FES) by applying a spot size detection (SSD) method to distribution of the 1st-order diffractive light beams received in the 1st-order optical detection pattern.

9. The optical pickup device according to claim 7, wherein the light receiving unit calculates a zero-order tracking error signal by applying a push-pull (PP) method to distribution of the zero-order diffractive light beams received in the zero-order optical detection pattern, calculates a 1st-order tracking error signal by applying a correct far field (CFF) method to distribution of the 1st-order diffractive light beams received in the 1st-order optical detection pattern, and calculates a tracking error signal by combining the zero-order tracking error signal with the 1st-order tracking error signal.

10. The optical pickup device according to claim 5, wherein the light receiving unit includes:
a zero-order optical detection pattern divided into two sections adapted to receive the 2-section zero-order diffractive light beams, respectively, in which the 2-section patterns receiving the zero-order diffractive light beams are each divided into a plurality of sections; and
a 1st-order optical detection pattern where 2-section patterns are formed to receive the 2-section 1st-order diffractive light beams, respectively, in which the 2-section patterns receiving the 1st-order diffractive light beams are each divided into a plurality of sections.

11. The optical pickup device according to claim 10, wherein the light receiving unit calculates the focusing error signal (FES) by applying a spot size detection (SSD) method to distribution of the 1st-order diffractive light beams received in the 1st-order optical detection pattern.

12. The optical pickup device according to claim 10, wherein the light receiving unit calculates a zero-order tracking error signal by applying a push-pull (PP) method to distribution of the zero-order diffractive light beams received in the zero-order optical detection pattern, calculates a 1st-order tracking error signal by applying a correct far field (CFF) method to distribution of the 1st-order diffractive light beams, and calculates a tracking error signal by combining the zero-order tracking error signal with the 1st-order tracking error signal.

13. The optical pickup device according to claim 1, wherein the hologram optical element includes a diffraction pattern divided into two sections, and transmits a zero-order diffractive light beam divided into a plurality of zero-order diffractive light beams in the diffraction pattern such that the plurality of zero-order diffractive light beams are adjacent to each other, a +1st-order diffractive light beam divided into a plurality of +1st-order diffractive light beams in the diffraction pattern such that the plurality of 1st-order diffractive light beams are separated from each other, and −1st-order diffractive light beam divided into a plurality of −1st-order diffractive light beams in the diffraction pattern such that the plurality of −1st-order diffractive light beams are separated from each other to the light receiving unit.

14. The optical pickup device according to claim 13, wherein one of the zero-order diffractive light beams, one of the +1st-order diffractive light beams, and one of the −1st-order diffractive light beams form upright images on the light receiving unit, and the other one of the +1st-order diffractive light beams and the other one of the −1st-order diffractive light beams form handstand images on the light receiving unit.

15. The optical pickup device according to claim 13, wherein the light receiving unit includes:
a zero-order optical detection pattern divided into two sections adapted to receive the 2-section zero-order diffractive light beams, respectively;
a +1st-order optical detection pattern where 2-section patterns are formed to receive the 2-section +1st-order diffractive light beams, respectively, in which the 2-section patterns receiving the +1st-order diffractive light beams are each divided into a plurality of sections; and
a −1st-order optical detection pattern where 2-section patterns are formed to receive the 2-section −1st-order diffractive light beams, respectively.

16. The optical pickup device according to claim 15, wherein the light receiving unit calculates a focusing error signal (FES) by applying a spot size detection (SSD) method to distribution of the +1st-order diffractive light beams received in the +1st-order optical detection pattern.

17. The optical pickup device according to claim 15, wherein the light receiving unit calculates a zero-order tracking error signal by applying a push-pull (PP) method to distribution of the zero-order diffractive light beams received in the zero-order optical detection pattern, calculates a −1st-order tracking error signal by applying a correct far field (CFF) method to distribution of the −1st-order diffractive light beams received in the −1st-order optical detection pattern, and calculates a tracking error signal by combining the zero-order tracking error signal with the −1st-order tracking error signal.

18. The optical pickup device according to claim 13, wherein the light receiving unit includes:
a zero-order optical detection pattern divided into two sections adapted to receive the 2-section zero-order diffractive light beams, respectively, in which the 2-section patterns receiving the zero-order diffractive light beams are each divided into a plurality of sections;
a +1st-order optical detection pattern where 2-section patterns are formed to receive the 2-section +1st-order diffractive light beams, respectively, in which the 2-section patterns receiving the +1st-order diffractive light beams are each divided into a plurality of sections; and
a −1st-order optical detection pattern where 2-section patterns are formed to receive the 2-section −1st-order diffractive light beams, respectively.

19. The optical pickup device according to claim 18, wherein the light receiving unit calculates a focusing error signal (FES) by applying a spot size detection (SSD) method to distribution of the +1st-order diffractive light beams received in the +1st-order optical detection pattern.

20. The optical pickup device according to claim 18, wherein the light receiving unit calculates a zero-order tracking error signal by applying a push-pull (PP) method to distribution of the zero-order diffractive light beams received in the zero-order optical detection pattern, calculates a −1st-order tracking error signal by applying a correct far field (CFF) method to distribution of the −1st-order diffractive light beams received in the −1st-order optical detection pattern, and calculates a tracking error signal by combining the zero-order tracking error signal with the −1st-order tracking error signal.
